(19) United States
(12) Patent Application Publication
(10) Pub. No.: US 2010/0242764 A1
(43) Pub. Date: Sep. 30, 2010

(54) FOUNTAIN SOLUTION COMPOSITION FOR LITHOGRAPHIC PRINTING AND HEAT-SET OFFSET ROTARY PRINTING PROCESS

(76) Inventors: Yoichiro ARA, Shizuoka (JP); Akimitsu Haijima, Shizuoka (JP)

Correspondence Address: BIRCH STEWART KOLASCH & BIRCH, PO BOX 747, FALLS CHURCH, VA, 22040-0747, US

(21) Appl. No.: 12/730,685

(22) Filed: Mar. 24, 2010

(30) Foreign Application Priority Data
Mar. 25, 2009 (JP) 2009-074468

(51) Int. Cl. B41F 1/18; C09D 11/02

(52) U.S. Cl. 101/450.1; 106/31.13

(57) ABSTRACT

A fountain solution composition for lithographic printing characterized by comprising at least one selected from 2,4-diethyl-1,5-pentanediol, 2-butyl-2-ethyl-1,3-propanediol and 1,2-octanediol, and at least one selected from compounds represented by the following general formula (I) or (II):

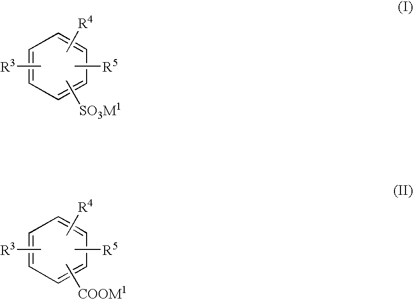

wherein R³ to R⁵ each independently represent hydrogen atom, an alkyl group having 1 to 4 carbon atoms, a hydroxyalkyl group having 1 to 4 carbon atoms, a hydroxyl group, a halogen atom, a mercapto group, —SO₃M¹ or —COOM¹, and M¹ represents hydrogen atom, an alkali metal or NH₄.

### BACKGROUND OF THE INVENTION

1. Field of the Invention

The present invention relates to fountain solution compositions for lithographic printing, more specifically to fountain solution compositions for offset printing process, which are preferably used for a rotary heat-set offset printing process.

2. Description of the Related Art

Lithographic printing is a process of printing, which advantageously utilizes the property that water and oil are essentially not miscible with each other, and consists of two areas: one receives water and repels an oil based ink, and the other receives the oil based ink and repels water. The former one is the non-image area, and the latter is the image area. Wetting the non-image area with a fountain solution enlarges the surface chemical difference between the image and non-image areas, thereby enhancing the ink repellency of the non-image area and the ink receptivity of the image area.

Lithographic printing machines typically employ offset printing methods, in which ink and fountain solution are supplied onto the plate where ink attaches to the image area and fountain solution attaches to the non-image area to create an image, which image on the plate in turn becomes transferred to the blanket and then to the paper from the blanket, thereby achieving printing. During this procedure, when continuing printing for a long period of time, there causes a problem so-called “blanket piling”, where the ink component and paper component gradually pile up on the non-image areas on the blanket. Specifically, rotary lithographic offset (rotary offset) printing is characterized by its long-term and continuous operatability and high productivity, however, had a considerable problem of causing blanket piling.

In the blanket piling phenomena, the ink on the image area tends to be extruded and deposited on especially the back side of the rotation (the gripper end side), and said deposition inhibits ink transfer from the blanket to paper resulting in insufficient attachment of ink. In order to remove the deposit, printing operation has to be stopped for cleaning the blanket, giving rise remarkably to increase in paper waste and reduction of the productivity. Therefore, an improvement has been demanded.

Some solutions for blanket piling have been proposed such as an ink composition for rotary lithographic offset printing comprising lanoline with an acid value of less than 1.0 in an amount of 1-5% by weight (see Patent Document 1), and a pigment coated paper for offset printing characterized by being coated with a coating composition wherein a ratio between a particular adhesive agent and the pigment is defined (see Patent Document 2).

However, limitation to particular inks or printing papers cannot be satisfactory under circumstances where use of wide variety of inks or papers is desired. Therefore, improvement of blanket piling still remains as an important issue.

Commonly known fountain solutions include aqueous solutions containing alkali metal salt or ammonium salt of dichromic acid, phosphorus acid or salt thereof such as ammonium phosphate, gum Arabic, colloid substances such as carboxymethyl cellulose (CMC) and the like. However, fountain solution containing only these compounds has a drawback in that it shows a difficulty in wetting the non-image area of the plate evenly and often causes undesired stains on the printed matters. Also, there has been a problem that the control of fountain solution supply requires substantial training.

In order to improve the above drawback, Dahlgren system using an aqueous solution containing about 20-25% of isopropyl alcohol has been proposed. This method is advantageous in many points, including operationality and quality of the printed matters, by improving wetting of the non-image area, reducing the required amount of fountain solution, facilitating balancing of the amounts of printing ink and water to be supplied, reducing the emulsifying amount of fountain solution into the printing ink and further by improving the transfer efficiency of the printing ink to the blanket. However, as isopropyl alcohol is volatile, a special apparatus is required in order to maintain a certain level of isopropyl alcohol in fountain solution, which leads to an increase of the cost. Further, isopropyl alcohol has a peculiar unpleasant odor, and a toxicity problem, therefore not favorable for the working environment. Application of a fountain solution containing isopropyl alcohol to offset printing where a common dampening roller is used has been problematic since isopropyl alcohol evaporates on the roller and on the plate surface and fails in exerting its effect.

Fountain solutions free from isopropyl alcohol have been proposed such as a fountain solution containing compounds with ethylenediamine to which ethylene oxide and propylene oxide are attached (see Patent Documents 3 and 4), and a fountain solution containing compounds with diethylenetriamine to which ethylene oxide and propylene oxide are attached (see Patent Document 5). However, these still tended to cause blanket piling, and an improvement thereof has been demanded.

On the other hand, a technique using a water-soluble organic polymer for improving wettability of printing cylinder has been proposed and it utilizes a fountain solution containing naturally occurring collagen/elastin, which are soluble to a weak acid aqueous medium (see Patent Document 6). It is also disclosed therein that the wettability becomes further improved by inclusion of a long chain (n≧6) non-polymeric alcohol and/or alkane diol having a hydroxyl group at (1,2)- or (1,3)-position. However, a method for improving blanket piling is not explicitly mentioned in the above prior arts.

Further, as a method being free from isopropyl alcohol wherein the similar wettability is obtained as isopropyl alcohol is used, and an excess emulsification of a printing ink, ink-stain on dampening roller and erosion to image areas on CTP (computer to plate) type-printing plates are prevented, a fountain solution composition comprising 2,4-diethyl-1,5-pentanediol has been proposed (see Patent Document 7). However, there is no description relating to blanket piling in the prior art, and the effect on blanket piling thereby has not been known. Assuming that 2,4-diethyl-1,5-pentanediol is added in such an amount that an effect of inhibiting blanket piling is shown, since the solubility of the compound in water is extremely small, when a concentrated solution (the solution having a high concentration of the solvent) is diluted to prepare a solution for practical use (generally, 1-5% aqueous solution), a deposition may be generated and eventually no effect of inhibiting blanket piling appears, and therefore the improvement has been desired.

[Patent Document 1] JP 2006-328299 A

[Patent Document 2] JP 2006-322114 A

[Patent Document 3] JP 2007-50665 A

[Patent Document 4] JP 2007-168124 A

[Patent Document 5] JP 2007-55182 A

[Patent Document 6] JP S61-189997 A

[Patent Document 7] JP 2008-119922 A

### DISCLOSURE OF THE INVENTION

### Problem to be solved by the Invention

An object of the present invention is to provide a method for improving blanket piling, and in particular to provide a fountain solution composition which is capable of improving blanket piling. An object of the present invention is also to provide a concentrated fountain solution composition which can prevent deposition of a slightly water soluble compound, such a deposition being possibly generated when a user dilutes the concentrated fountain solution composition to prepare a solution for practical use, and can provide an aqueous solution which is uniform and stable when used, as well as capable of exhibiting an effect of improving blanket piling.

### Means to Solve the Problem

In order to achieve the objects described above, the present inventors extensively studied to discover that blanket piling is significantly improved by adding particular diol compounds and particular another compounds to a fountain solution. Further, a concentrated fountain solution composition comprising the diol compounds and the another compounds can be diluted to provide a fountain solution composition when used, which is uniform and stable in terms of the composition when used, without causing deposition of components contained in the composition. The present inventors then achieved the invention on the basis of these findings.

Accordingly, the present invention is a fountain solution composition for lithographic printing characterized by comprising at least one selected from 2,4-diethyl-1,5-pentanediol, 2-butyl-2-ethyl-1,3-propanediol and 1,2-octanediol, and at least one selected from compounds represented by the following general formula (I) or (II):

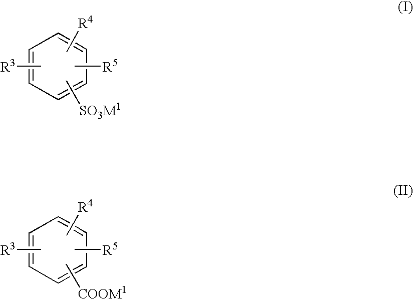

wherein R³ to R⁵ each independently represent hydrogen atom, an alkyl group having 1 to 4 carbon atoms, a hydroxyalkyl group having 1 to 4 carbon atoms, a hydroxyl group, a halogen atom, a mercapto group, —SO₃M¹ or —COOM¹, and M¹ represents hydrogen atom, an alkali metal or NH₄.

Examples of the compound represented by the above general formula (I) include m-xylene sulfonic acid, sodium m-xylene sulfonate, and potassium m-xylene sulfonate.

As one embodiment of the fountain solution composition for lithographic printing according to the present invention, there is the fountain solution composition further comprising at least one compound represented by the following general formula (III):

R₁—O—(CH₂CH₂O)ₘ—H (III)

wherein R₁ represents an alkyl group having 1 to 4 carbon atoms, and m represents an integer of 1 to 3.

As another embodiment of the fountain solution composition for lithographic printing according to the present invention, there is the fountain solution composition described above further comprising a pyrrolidone derivative represented by the following general formula (VI):

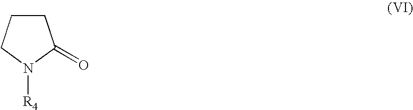

wherein R₄ represents an alkyl group having 2 to 12 carbon atoms.

In yet another embodiment of the fountain solution composition of the invention, the fountain solution composition further comprises at least one selected from the group consisting of acetylene glycols, acetylene alcohols, and an adduct compound of ethylene oxide and/or propylene oxide thereto.

The present invention is also directed to a concentrated fountain solution composition for lithographic printing characterized by comprising at least one diol compound selected from 2,4-diethyl-1,5-pentanediol, 2-butyl-2-ethyl-1,3-propanediol and 1,2-octanediol in an amount of 5 to 25% by weight, and at least one selected from compounds represented by the above general formula (I) or (II) in an amount of 0.3 to 2 times with respect to the amount of the diol compound. Said concentrated fountain solution composition can be diluted from 30 to 100 fold with water to prepare a fountain solution, and said fountain solution can be used for heat-set offset rotary printing process. Accordingly, the present invention is also directed to a rotary heat-set offset printing process wherein a fountain solution composition obtained by diluting the above concentrated fountain solution composition from 30 to 100 fold with water is used to print. In such a rotary heat-set offset printing process, an ink for rotary offset of a heat-set type can be used.

### EFFECT OF THE INVENTION

The fountain solution composition of the present invention represses the occurrence of blanket piling, and stably produces printings with high quality even through a continuous printing operation for a long period of time. In addition, the concentrated fountain solution composition according to the present invention prevents the deposition of a slightly water soluble compound, which deposition is a concern and possibly occurs when said concentrated fountain solution composition is diluted to prepare a solution for practical use, so as to obtain a diluent that is uniform and stable in terms of composition thereof, and therefore said concentrated fountain solution composition can provide a fountain solution that is uniform and stable in terms of composition thereof. According to the fountain solution composition according to the present invention, the use of volatile organic solvents such as isopropyl alcohol is not required, and therefore the operational environment is favorable, and scumming on printed matter is hardly generated, and favorable printing performance is attained without problems in printing such as the ink-stain (ink feedback) on the dampening roller.

### MODE FOR CARRYING OUT THE INVENTION

The present invention will be described in its detail below. In the present invention, at least one diol compound selected from 2,4-diethyl-1,5-pentanediol, 2-butyl-2-ethyl-1,3-propanediol and 1,2-octanediol is used, and in particular the use of 2-butyl-2-ethyl-1,3-propanediol shows remarkably the effect of the present invention.

An appropriate amount of the diol compound of the invention to be added is suitably 0.001 to 2.0% by weight based on the total weight of the fountain solution composition when used, preferably 0.01 to 1.0% by weight, more preferably 0.05 to 0.7% by weight, and further preferably 0.1 to 0.5% by weight based on the total weight of the fountain solution composition when used.

When the amount of the diol compound is too small, an effect of inhibiting blanket piling according to the present invention is not sufficient. On the other hand, when the amount of the diol compound is too large, inferior dissolution tends to occur, and when a concentrated solution is prepared and then diluted to prepare a solution for practical use, deposition of a slightly water soluble compound is easily generated, it follows that it is difficult to obtain a solution for practical use which is uniform and stable.

The fountain solution composition of the invention can comprise one or more than one diol compounds. As one example of the fountain solution composition of the invention, there is the fountain solution comprising two or more diol compounds, wherein 2-butyl-2-ethyl-1,3-propanediol represents at least 1% by weight of the total weight of diol compounds. In this embodiment, 2-butyl-2-ethyl-1,3-propanediol represents preferably at least 3% by weight, and more preferably at least 10% by weight of the total weight of diol compounds. In the above fountain solution composition comprising two or more diol compounds, the diol compound to be used in combination with 2-butyl-2-ethyl-1,3-propanediol includes specifically 2,4-diethyl-1,5-pentanediol.

The fountain solution composition according to present invention further comprises at least one selected from the benzenesulfonic acid and a derivative thereof represented by the following general formula (I) and the benzenecarboxylic acid and a derivative thereof represented by the following general formula (II). These compounds are described in detail below.

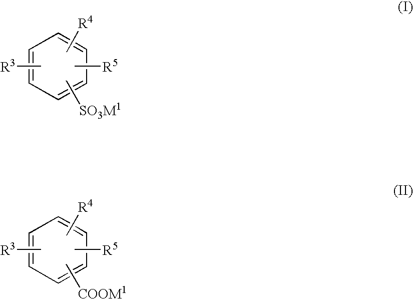

wherein R³ to R⁵ each independently represent hydrogen atom, an alkyl group having 1 to 4 carbon atoms, a hydroxyalkyl group having 1 to 4 carbon atoms, a hydroxyl group, a halogen atom, a mercapto group, —SO₃M¹ or —COOM¹, and M¹ represents hydrogen atom, an alkali metal or NH₄.

R³ to R⁵ each preferably represent hydrogen atom, methyl group or ethyl group. Among compounds represented by the formula (I) and compounds represented by the general formula (II), compounds represented by the general formula (I) are preferably used.

Examples of the compound represented by the general formula (I) or (II) include benzenesulfonic acid, p-toluenesulfonic acid, cumenesulfonic acid, m-xylenesulfonic acid, p-xylenesulfonic acid, 2,4,6-trimethylsulfonic acid, 4-ethyl-benzenesulfonic acid, phenolsulfonic acid, o-cresolsulfonic acid, m-cresolsulfonic acid, 1,4-benzenedisulfonic acid, 2,5-dimethyl-1,3-benzenesulfonic acid, 2,5-dihydroxy-benzenesulfonic acid, 4-chlorobenzenesulfonic acid, 4-(hydroxymethyl)benzenesulfonic acid, p-toluenecarboxylic acid, m-xylenecarboxylic acid, benzoic acid, salicylic acid, isophthalylsulfonic acid, gallic acid, thiosalicylic acid, sulfosalicylic acid, 4-chlorobenzoic acid, 2,4,5-trichlorobenzoic acid, 2,3,6-trichlorobenzoic acid, 4-methylsalicylic acid, phthalic acid, isophthalic acid, 2,4,6-trimethylbenzoic acid, 2,4,6-trihydroxybenzoic acid, and the like. Examples also include the alkali metal salts (sodium, potassium, lithium salts) thereof, ammonium salt thereof and the like. Among these, preferred are p-toluenesulfonic acid, sodium p-toluenesulfonate, m-xylenesulfonic acid, sodium m-xylenesulfonate and potassium m-xylenesulfonate, and particularly preferred are m-xylenesulfonic acid, sodium m-xylenesulfonate and potassium m-xylenesulfonate.

At least one selected from compounds represented by the above general formula (I) or (II) is used in an amount that is suitably 0.01 to 10 times, preferably 0.1 to 5 times and more preferably 0.3 to 2 times with respect to the amount of the above diol compound, in the fountain solution composition when used.

In preparing the concentrated fountain solution composition, at least one selected from compounds represented by the general formula (I) or (II) is also added in an amount that is suitably 0.01 to 10 times, preferably 0.1 to 5 times and more preferably 0.3 to 2 times with respect to the content of the above diol compound. In the concentrated fountain solution composition, at least one selected from compounds represented by the general formula (I) or (II) can be present at the above ratio to prevent the deposition of the diol compound, that deposition is a concern and possibly occurs when the concentrated fountain solution composition is diluted to prepare the solution for practical use, so as to easily obtain a diluent that is uniform and stable in terms of the composition thereof, in other words, to easily obtain a fountain solution that is uniform and stable in terms of the composition thereof.

It is preferable that the fountain solution composition would be generally used by diluting a concentrated solution before use in terms of transportation cost, storage space, and production cost including the cost of packaging materials. The dilution rate is preferably 10 to 200 fold, more preferably 20 to 150 fold, and the most preferably 30 to 100 fold. Therefore, the concentration of the composition in the concentrated solution is adjusted to a level that would give the above concentration of the fountain solution composition of use upon dilution. Higher concentration is preferred in respect of cost; however, excessive levels of concentration may cause some problems such as deposition or liquid separation, therefore being not favorable.

As a specific embodiment of the concentrated fountain solution composition, there is a concentrated fountain solution composition comprising at least one diol compound selected from 2,4-diethyl-1,5-pentanediol, 2-butyl-2-ethyl-1,3-propanediol and 1,2-octanediol in an amount of 5 to 25% by weight, and at least one selected from compounds represented by the above general formula (I) or (II) in an amount of 0.01 to 10 times, preferably 0.1 to 5 times and more preferably 0.3 to 2 times with respect to the amount of the diol compound.

The fountain solution composition of the present invention may further comprises at least one compound represented by the following general formula (III);

R₁—O—(CH₂CH₂O)ₘ—H (III)

wherein R₁ represents an alkyl group having 1 to 4 carbon atoms, and m represents an integer of 1 to 3.

In the compound of the general formula (III), specifically, R¹ represents a straight or branched chain alkyl group having 1 to 4 carbon atoms, including methyl group, ethyl group, propyl group, isopropyl group, n-butyl group, isobutyl group, t-butyl group and the like. In the light of enhancing a solubility of the diol compound and inhibiting blanket piling, R¹ represents preferably n-butyl group, isobutyl group or t-butyl group, and most preferably isobutyl group. Further, m represents an integer of 1 to 3, preferably 1 or 2, and most preferably 1.

Examples of the compound represented by the general formula (III) include ethylene glycol mono t-butyl ether, ethylene glycol monoisobutyl ether, ethylene glycol mono n-butyl ether, ethylene glycol monomethyl ether, ethylene glycol monoethyl ether, ethylene glycol mono n-propyl ether, ethylene glycol monoisopropyl ether, diethylene glycol mono t-butyl ether, diethylene glycol monoisobutyl ether, diethylene glycol mono n-butyl ether, triethylene glycol mono t-butyl ether, tetraethylene glycol mono n-butyl ether, triethylene glycol monoisobutyl ether, diethylene glycol monomethyl ether, diethylene glycol monoethyl ether, dietylene glycol mono n-propyl ether, diethylene glycol monoisopropyl ether and the like. These compounds can be used either alone or in combination of more than one.

Among these, ethylene glycol mono t-butyl ether, ethylene glycol monoisobutyl ether, ethylene glycol mono n-butyl ether, diethylene glycol mono t-butyl ether, diethylene glycol monoisobutyl ether and diethylene glycol mono n-butyl ether are preferable, and ethylene glycol monoisobutyl ether, diethylene glycol monoisobutyl ether and diethylene glycol mono n-butyl ether are specifically preferable, and ethylene glycol monoisobutyl ether can be most preferably used. An appropriate amount of the compound represented by the general formula (III) to be added is 0.05 to 5.0% by weight based on the total weight of the fountain solution composition when used, because within the above range, the composition would exhibit a sufficient effect of blanket piling repression, while not causing problems such as roller stripping or poor printing durability on a printing plate. More preferably, the amount to be added is 0.1 to 3.0% by weight.

The fountain solution composition of the present invention can further comprise at least one compound selected from an adduct compound of ethylene oxide and propylene oxide to ethylenediamine and an adduct compound of ethylene oxide and propylene oxide to diethylenetriamine.

These compounds will be described as follows.

[Adduct Compound of Ethylene Oxide and Propylene Oxide to Ethylenediamine]

An adduct compound of ethylene oxide and propylene oxide to ethylenediamine used for the invention has an appropriate weight-average molecular weight of 500 to 20000, preferably 500 to 5000, more preferably 800 to 1500, and most preferably about 1000.

In the compound, a molar ratio of attachment of ethylene oxide and propylene oxide is suitably in the range of 5:95 to 50:50, and more preferably in the range of 20:80 to 35:65 in terms of sufficient printing performance.

Bond-structures of ethylene oxide and propylene oxide in the compound include a block structure in which ethylene oxide is added first followed by propylene oxide, block structure in which propylene oxide is added first followed by ethylene oxide, and random structure in which ethylene oxide and propylene oxide are added simultaneously, however, any of these structures displays almost the same effect.

The adduct compound of ethylene oxide and propylene oxide to ethylenediamine used for the invention can be produced by a conventional method, for example, by allowing ethylene oxide and/or propylene oxide to react with ethylenediamine in the presence of a catalyst.

The adduct compound of ethylene oxide and propylene oxide to ethylenediamine used for the invention is specifically represented by formula (IV) as follows.

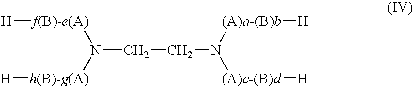

wherein A and B each independently represents —CH₂CH₂O— or —CH₂CH(CH₃)O—, A and B are different groups from each other, a to h each represents an integer of 0 to 50, wherein at least one of a, c, e and g is not less than 1, and at least one of b, d, f and h is not less than 1. The symbols a to h take certain values so that the molecular weight of the compound in total would be 500 to 20000. Each copolymer chain may be in either a block or random structure.

The molecular weight of the compound and the ratio of ethylene oxide and propylene oxide can be determined, for example, by measuring a hydroxyl value and an amine value, or by NMR measurement.

The compound of formula (IV) is preferably represented by formula (IV′) as follows.

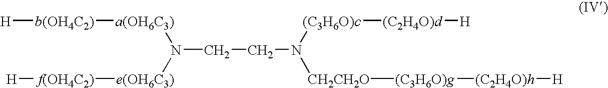

wherein a, b, c, d, e, f, g and h each represent an integer of 0 to 50, wherein at least one of a, c, e and g is not less than 1, and at least one of b, d, f and h is not less than 1.

The compound of above formula (IV′) suitably has a weight-average molecular weight of 500 to 20000, preferably 500 to 5000, and more preferably 800 to 1500. The symbols a to h take certain values so that the molecular weight of the compound in total would be 500 to 20000, however, a to h are preferably 1 to 10, and in particular, 2 to 4.

Such compounds would not adversely affect image areas, even when the remaining water drops are left and becomes concentrated by evaporation during run-down time of the printing machine. These compounds can take the place of isopropyl alcohol without being combined with volatile organic solvents, however, tend to deteriorate blanket piling and ink-stain (ink feedback) on the dampening roller. By combining with the diol compound used for the present invention, the above compound would be able to take place of isopropyl alcohol without aggravating blanket piling and ink-stain (ink feedback) on the dampening roller.

In the compound, a suitable molar ratio of added ethylene oxide and added propylene oxide is suitably in the range of 5:95 to 50:50, and more preferably in the range of 20:80 to 35:65 in terms of sufficient printing performance.

[Adduct Compound of Ethylene Oxide and Propylene Oxide to Diethylenetriamine]

An adduct compound of ethylene oxide and propylene oxide to diethylenetriamine used for the invention has an appropriate weight-average molecular weight of 500 to 3000, preferably 800 to 2000, and most preferably about 1000.

Compounds having such molecular weights would not adversely affect image areas, even when the remaining water drops are left and becomes concentrated by evaporation during run-down time of the printing machine. These compounds can take place of isopropyl alcohol without being combined with volatile organic solvents.

In the compound, a suitable molar ratio of added ethylene oxide and added propylene oxide is suitably in the range of 5:95 to 50:50, and more preferably in the range of 20:80 to 35:65 in terms of sufficient printing performance.

Bond-structures of ethylene oxide and propylene oxide include a block structure in which ethylene oxide is attached first followed by propylene oxide, block structure in which propylene oxide is attached first followed by ethylene oxide, and random structure in which ethylene oxide and propylene oxide are attached simultaneously, however, any of these structures displays almost the same effect.

The adduct compound of ethylene oxide and propylene oxide to diethylenetriamine used for the invention can be produced by a conventional method, for example, by allowing ethylene oxide and/or propylene oxide to react with diethylenetriamine in the presence of a catalyst. Alternatively, one can cool diethylenetriamine along with acetonitrile in an ice bath and add propylene oxide thereto, and further add ethylene oxide thereto to allow to react, then remove the deposit from the mixture by filtration, whereby obtain the adduct compound of propylene oxide/ethylene oxide to diethylenetriamine.

The adduct compound of propylene oxide/ethylene oxide to diethylenetriamine used for the invention is specifically represented by formula (V) as follows.

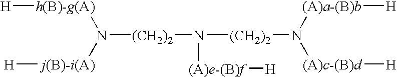

wherein A and B each independently represents —CH₂CH₂O— or —CH₂CH(CH₃)O—, A and B are different groups from each other, a to j each represents an integer not less than 1. Each copolymer chain may be in either a block or random structure.

In the formula, the symbols a to j take certain values so that the molecular weight of the compound in total would be 500 to 3000, however, a to j are preferably 1 to 6, and in particular, 2 to 3.

The molecular weight of the compound and the ratio of ethylene oxide and propylene oxide can be determined, for example, by measuring a hydroxyl value and an amine value or by NMR measurement.

Isopropyl alcohol can be replaced by the above compound contained in an amount of 0.01 to 1% by weight, preferably 0.05 to 0.5% by weight, in a fountain solution composition when used, and then an excellent printability would be displayed. Such compounds would not adversely affect image areas, even when the remaining water drops are left and becomes concentrated by evaporation during run-down time of the printing machine after using the fountain solution. However, these compounds tend to deteriorate blanket piling and ink-stain (ink feedback) on the dampening roller. By combining with the diol compound used for the invention, the above compound would be able to take the place of isopropyl alcohol without aggravating blanket piling and ink-stain (ink feedback) on the dampening roller.

The fountain solution composition of the invention may include other components as follows:

(a) auxiliary agent for wettability improvement
(b) water-soluble polymer compound
(c) pH adjusting agent
(d) chelating agent
(e) odor masking agent
(f) others ((i) preservatives, (ii) colorant, (iii) anticorrosives, (iv) antifoaming agent, etc.)

As for (a) auxiliary agents for wettability improvement, surfactants and other solvents can be used. Among surfactants, for example, anionic surfactants include fatty acid salts, abietate, hydroxyalkanesulfonate, alkanesulfonate, dialkyl sulfosuccinate, linear alkylbenzene sulfonate, branched alkylbenzene sulfonate, alkylnaphthalenesulfonate, alkylphenoxy polyoxyethylene propylsulfonate, polyoxyethylene alkylsulfenyl ether salt, N-methyl-N-oleyl taurine sodium salt, N-alkyl sulfosuccinic acid monoamide disodium salt, petroleum sulfonate, sulfated castor oil, sulfated beef tallow oil, sulfuric ester salt of fatty acid alkyl ester, alkyl sulfuric acid ester salt, polyoxyethylene alkyl ether sulfuric ester salt, fatty acid monoglyceride sulfuric ester salt, polyoxyethylene alkylphenyl ether sulfuric ester salt, polyoxyethylene styrylphenyl ether sulfuric ester salt, alkyl phosphoric ester salt, polyoxyethylene alkyl ether phosphoric ester salt, polyoxyethylene alkylphenyl ether phosphoric ester salt, partially saponified product of styrene-maleic anhydride copolymer, partially saponified product of olefin-maleic anhydride copolymer, naphthalene sulfonate formalin condensate and the like. Among these, dialkyl sulfosuccinate, alkyl sulfuric acid ester salt and alkylnaphthalenesulfonate are particularly preferably used.

Nonionic surfactants include polyoxyethylene alkyl ether, polyoxyethylene alkylphenyl ether, polyoxyethylene polystyrylphenyl ether, polyoxyethylene polyoxypropylene alkyl ether, glycerol fatty acid partial ester, sorbitan fatty acid partial ester, pentaerythritol fatty acid partial ester, propylene glycol mono fatty acid ester, sucrose fatty acid partial ester, polyoxyethylene sorbitan fatty acid partial ester, polyoxyethylene sorbitol fatty acid partial ester, polyethylene glycol fatty acid ester, polyglycerin fatty acid partial ester, polyoxyethylenated castor oil, polyoxyethylene glycerol fatty acid partial ester, fatty acid diethanol amide, N,N-bis-2-hydroxy alkylamine, polyoxyethylene alkylamine, triethanolamine fatty acid ester, trialkylamine oxide and the like. In addition, fluorochemical surfactants and silicon surfactants may be used. Among these, polyoxyethylene alkylphenyl ether and polyoxyethylene-polyoxypropylene block polymer are preferably used. In addition, there are surfactants of silicon derivatives and fluorine derivatives. In case of using a surfactant, an appropriate content thereof is not more than 1.0% by weight, preferably 0.001 to 0.5% by weight in the fountain solution composition when used, in view of foaming. In addition, combination of two or more surfactants can be employed.

As for another auxiliary agent or wetting solvent, 3-methoxy-3-methyl butanol, 3-methoxybutanol, ethylene glycol, diethylene glycol, triethylene glycol, butylene glycol, hexylene glycol, glycerol, diglycerol, polyglycerin, trimethylolpropane and the like can be used. These solvents can be used either alone or in combination of more than one. These solvents are appropriately used in a range of 0.1 to 3% by weight based on the total weight of the fountain solution composition when used, and preferably 0.3 to 2% by weight.

As for another auxiliary agent, a pyrrolidone derivative represented by the following general formula (VI) may be used.

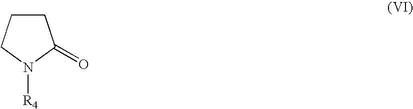

wherein R₄ represents an alkyl group having 2 to 12 carbon atoms.

Specific examples of the pyrrolidone derivative include ethyl pyrrolidone, butyl pyrrolidone, pentapyrrolidone, hexapyrrolidone, octylpyrrolidone, laurylpyrrolidone and the like. These compounds can be used either alone or in combination of more than one. Among these, those wherein R₄ represents an alkyl having 6 or more carbon atoms in the formula (VI) are preferable, and octylpyrrolidone is particularly preferable. The compound represented by the general formula (VI) is used appropriately in an amount of 0.0001 to 1.0% by weight on the basis of the total weight of the fountain solution composition when used, and more preferably 0.001 to 0.1% by weight.

The fountain solution composition of the invention can also comprise at least one selected from the group consisting of acetylene glycols, acetylene alcohols, and an adduct compound of ethylene oxide and/or propylene oxide thereto. Specific examples of said compounds include 3,5-dimethyl-1-hexyne-3-ol, 2,5-dimethyl-3-hexyne-2,5-diol, 2,4,7,9-tetramethyl-5-decyne-4,7-diol, 3,6-dimethyl-4-octyne-3,6-diol, 2-butyne-1,4-diol, 3-methyl-1-butyne-3-ol, an adduct compound of ethylene oxide and/or propylene oxide to the above compound, and the like. Among these, 3,6-dimethyl-4-octyne-3,6-diol, 2,4,7,9-tetramethyl-5-decyne-4,7-diol, and an adduct compound of 4 to 10 ethylene oxides to 2,4,7,9-tetramethyl-5-decyne-4,7-diol are preferable. These compounds are used appropriately in an amount of 0.0001 to 1.0% by weight on the basis of the total weight of the fountain solution composition when used, and more preferably 0.001 to 0.1% by weight.

The following compounds can be added to the fountain solution composition, if desired, for the purpose of adjustment of dynamic surface tension, solubilization, control on a mix rate (emulsification rate) of printing ink into a proper range, or the like: 2-ethyl-1,3-hexanediol, an adduct compound of ethylene oxide and/or propylene oxide to 2-ethyl-1,3-hexanediol, an adduct compound of propylene oxide to trimethylolpropane, an adduct compound of propylene oxide to glycerin, an adduct compound of propylene oxide to sorbitol, tetrahydrofurfuryl alcohol, and the like. Among these, preferred as an auxiliary agent for adjustment of dynamic surface tension is 2-ethyl-1,3-hexanediol, and preferred as an agent for solubilization is tetrahydrofurfuryl alcohol. As an agent for controlling an ink emulsification rate, an adduct compound of ethylene oxide to 2-ethyl-1,3-hexanediol, an adduct compound of propylene oxide to trimethylolpropane and the like may be preferably used. These compounds can be used either alone or in combination of more than one. These compounds are used appropriately in an amount of 0.01 to 7% by weight on the basis of the total weight of the fountain solution composition when used, and more preferably 0.05 to 5% by weight.

The water-soluble polymer compounds (b) used for the fountain solution composition of the invention include natural products and denatured products thereof such as gum Arabic, starch derivatives (e.g. dextrin, enzymolysis dextrin, hydroxypropylated enzymolysis dextrin, carboxymethylated starch, phosphoric acid starch, octenylsuccinated starch), alginate, cellulose derivatives (e.g. carboxymethyl cellulose, carboxyethyl cellulose, methyl cellulose, hydroxypropyl cellulose, hydroxypropylmethyl cellulose, hydroxyethyl cellulose) and the like, and synthetic products such as polyethylene glycol and copolymers thereof, polyvinyl alcohol and derivatives thereof, polyvinylpyrrolidone, polyacrylamide and copolymers thereof, polyacrylic acid and copolymers thereof, a vinyl methyl ether/maleic anhydride copolymer, a vinyl acetate/maleic anhydride copolymer, polystyrene sulfonic acid and copolymers thereof, and the like. The appropriate content of the water-soluble polymer is 0.0001 to 0.1% by weight, preferably 0.0005 to 0.05% by weight, based on the total weight of the fountain solution composition when used.

Among the water-soluble polymer compounds listed above, polyvinylpyrrolidone, hydroxypropyl cellulose, and hydroxypropylmethyl cellulose are preferably used for the invention. Polyvinylpyrrolidone contained in the fountain solution composition refers to a homopolymer of vinylpyrrolidone. Suitably, the molecular weight of polyvinylpyrrolidone is 200 to 3,000,000, preferably 300 to 500,000, and more preferably 300 to 100,000. The molecular weight of 300 to 30,000 is particularly preferred.

These polyvinylpyrrolidone can be used either alone or in combination of more than one with different molecular weights. In addition, they can be combined with polyvinylpyrrolidone of low molecular weight, such as vinylpyrrolidone oligomers with degree of polymerization of 3 to 5.

Such polyvinylpyrrolidone is commercially available. For example, polyvinylpyrrolidone in different grades, such as K-15, K-30, K-60, K-90, K-120 and the like from ISP Co., Ltd. can be usefully employed.

The appropriate polyvinylpyrrolidone content in the fountain solution composition when used is 0.001 to 0.3% by weight, and preferably 0.005 to 0.2% by weight.

The fountain solution composition of the invention preferably comprises at least one compound selected from sugars. The sugar for use can be selected from monosaccharide, disaccharide, oligosaccharide and sugar alcohols thereof obtainable by hydrogenation. Examples of sugars include D-erythrose, D-threose, D-arabinose, D-ribose, D-xylose, D-erythro-pentulose, D-allulose, D-galactose, D-glucose, D-mannose, D-talose, β-D-fructose, α-L-sorbose, 6-deoxy-D-glucose, D-glycero-D-galactose, α-D-allulo-heptulose, β-D-altro-3-heptulose, saccharose, lactose, D-maltose, isomaltose, inulobiose, maltotriose, D,L-arabite, ribitol, xylitol, D,L-sorbitol, D,L-mannite, D,L-idit, D,L-talite, dulcite, allodulcite, maltitol, reduced starch syrup and the like. These sugars can be used either alone or in combination of more than one.

The appropriate content of at least one compound selected from sugars is 0.01 to 1% by weight, and preferably 0.1 to 0.8% by weight, in the fountain solution composition when used.

Water-soluble organic and/or inorganic acids and/or salts thereof can be used as pH adjusting agents (c) used for the fountain solution composition of the invention. These compounds act as a pH adjusting agent or buffer in the fountain solution and can be effectively used for adequate etching or anticorrosive treatment. Preferable organic acid includes, for example, citric acid, ascorbic acid, malic acid, tartaric acid, lactic acid, acetic acid, gluconic acid, acetic acid, hydroxyacetic acid, oxalic acid, malonic acid, levulinic acid, sulfanilic acid, p-toluenesulfonic acid, phytic acid, an organic phosphonic acid and the like. Inorganic acid includes phosphoric acid, nitric acid, sulfuric acid, polyphosphoric acid and the like. In addition, alkali metal salts, alkaline earth metal salts, ammonium salts or organic amine salts of these organic and/or inorganic acids can be preferably used, and such organic and inorganic acids and salts thereof can be used either alone or in combination of more than one. The amount of such a pH adjusting agent to be added to the fountain solution composition of the invention is preferably in the range of 0.001 to 0.3% by weight. Although the pH adjusting agent is preferably used within an acidic condition of pH 3-7 in the fountain solution composition, it can also be used within alkali condition of pH 7-11 in the presence of alkali metal hydroxide, phosphoric acid, alkali metal salt, alkali metal salt of carbonic acid, silicate and the like.

The fountain solution composition of the invention may further comprise a chelating agent (d). A fountain solution composition is usually prepared by diluting the concentrated solution with tap water, well water or the like, and components of tap water or well water such as calcium ion may adversely affect printing and make printing matter stain-prone. Under such condition, addition of a chelating agent may solve the above problem. Examples of preferred chelating agents include ethylenediaminetetraacetic acid and potassium salts and sodium salts thereof; diethylenetriaminepentaacetic acid and potassium salts and sodium salts thereof; triethylenetetraminehexaacetic acid and potassium salts and sodium salts thereof; hydroxyethylethylenediaminetriacetic acid and potassium salts and sodium salts thereof; nitrilotriacetic acid and sodium salts thereof; organic phosphonic acids such as 1-hydroxy ethane-1,1-diphosphonic acid and potassium salts and sodium salts thereof; aminotri (methylenephosphonic acid) and potassium salts and sodium salts thereof, and phosphonoalkanetricarboxylic acids. Organic amine salts are also effective instead of the sodium salts or potassium salts of the chelating agents above. Among these, chelating agents which are stable in the fountain solution composition when used and do not inhibit printing property are selected. The appropriate content of the chelating agent is 0.001 to 0.5% by weight, and preferably 0.002 to 0.25% by weight in the fountain solution composition when used.

Odor masking agents (e) include esters which is conventionally known to be used as flavors. Examples of odor masking agents include those represented by formula (VII) as follows.

R²—COOR³ (VII)

In the compound of formula (VII), R² is a C₁-C₁₅ alkyl, alkenyl or aralkyl group or phenyl group; in case where R² is alkyl or alkenyl, the number of carbon atoms therein is preferably 4 to 8; in case where R² represents an alkyl, alkenyl or aralkyl group, the group may be either linear or branched. Note that a suitable alkenyl group has one double bond. Aralkyl groups include a benzyl group, phenylethyl group and the like. One or more of hydrogen atoms of alkyl, alkenyl or aralkyl group or phenyl group represented by R² may optionally be substituted by hydroxy or acetyl groups. R³ is a C₃-C₁₀ alkyl, aralkyl or phenyl group, and may be either linear or branched; in case where R³ is an alkyl group, the number of carbon atoms therein is preferably from 3 to 9. Aralkyl groups include a benzyl group, phenylethyl group and the like.

Specific examples of odor masking agents (e) which may be used include esters of formic acid, acetic acid, propionic acid, butyric acid, isobutyric acid, 2-ethylbutyric acid, valeric acid, isovaleric acid, 2-methylvaleric acid, hexanoic acid (caproic acid), 4-methylpentanoic acid (isohexane acid), 2-hexenoic acid, 4-pentene acid, heptanoic acid, 2-methylheptane acid, octanoic acid (caprylic acid), nonanoic acid, decanoic acid (capric acid), 2-decenoic acid, lauric acid or myristic acid. In addition, odor masking agents also includes acetoacetic esters such as benzyl phenylacetate, ethyl acetoacetate and 2-hexyl acetoacetate. Among these, n-pentyl acetate, isopentyl acetate, n-butyl butyrate, n-pentyl butyrate and isopentyl butyrate are preferred and, in particular, n-butyl butyrate, n-pentyl butyrate and isopentyl butyrate are preferred. The appropriate content of such acid ester in the fountain solution composition is 0.0001 to 10% by weight, and preferably 0.001 to 1% by weight, based on the total weight of the fountain solution composition when used. Such odor masking agents may improve the working environment, and be used in combination with vanillin, ethyl vanillin and the like.

Preservatives (f)(i) used for the fountain solution composition of the invention include phenol or derivatives thereof, formalin, imidazole derivatives, sodium dehydroacetate, 4-isothiazolin-3-one derivatives, benztriazole derivatives, derivatives of amidine or guanidine, quaternary ammonium salt, pyridine, derivatives of quinoline or guanidine, derivatives of diazine or triazole, derivatives of oxazol or oxazin, bromonitro alcohols such as bromonitro propanol, 2,2-dibromo-2-nitro ethanol, 3-bromo-3-nitro pentane 2,4-diol, and the like. Preferable amount of the preservative to be added is such that stably exhibit its effect on bacteria, fungi, yeasts and the like, and varies with the types of the bacteria, fungi and yeasts, however, it is preferably 0.001 to 1.0% by weight relative to the fountain solution composition when used. It is also preferable to use preservatives in combination of more than one which are potent against a variety of bacteria, fungi and yeasts.

Food colorings and the like can be preferably used for invention as colorants (f)(ii). Examples of colorants include CI No. 19140 and 15985 for yellow pigments; CI No. 16185, 45430, 16255, 45380, and 45100 for red pigments; CI No. 42640 for purple pigment; CI No. 42090 and 73015 for blue pigment; CI No. 42095 for green pigment; and the like. Anticorrosives (f)(iii) which may be used for the invention include benzotriazole, 5-methylbenzotriazol, thiosalicylic acid, benzimidazole and derivatives thereof and the like. Silicone antifoaming agents are preferable for antifoaming agents (f)(iv) which may be used for the invention. Among these, either emulsion-dispersing type or solubilized type may be used.

The balance of the fountain solution composition according to the invention is water. Fountain solution compositions are generally concentrated in commercial products on a commercial basis. Accordingly, the concentrated solution can be obtained as an aqueous solution with the above components dissolved therein by using water, preferably desalted water, i.e. pure water. The concentrated solution is used by diluting about 10-200 fold, preferably about 20-150 fold and more preferably about 30-100 fold with tap water, well water or the like thereby making the fountain solution composition when used.

The fountain solution composition of the invention can be used for a variety of lithographic printing plates, and, in particular, can be preferably used for lithographic printing plates which can be obtained by imagewise exposure and development of a photo-sensitive lithographic printing plate (a printing plate which is preliminarily photosensitized and referred to as PS plate) onto the surface of an aluminum plate support. Preferable examples of such PS plates include a plate in which a photo-sensitive layer consisting of a mixture with diazo resin (salt of a condensation product of p-diazodiphenylamine and paraformaldehyde) and shellac is prepared on an aluminium plate as described in GB Patent No. 1,350,521, a plate in which a photo-sensitive layer consisting of a mixture with diazo resin and a polymer containing hydroxyethylmethacrylate unit or hydroxyethyl acrylate unit as the primary recurring unit is prepared on an aluminium plate as described in GB Patent Nos. 1,460,978 and 1,505,739, a negative-working PS plate in which a photo-sensitive polymer containing dimethylmaleimide group is prepared on an aluminium plate as described in JP H2-236552 A and JP H4-274429 A, and a positive-working PS plate in which a photo-sensitive polymer consisting of a mixture with o-quinonediazido photosensitive product and novolac phenol resin is prepared on an aluminium plate as described in JP S50-125806 A. Furthermore, the fountain solution composition can be used for burning-treated positive-working PS plates.

In the composition forming the above photosensitive layer, an alkali-soluble resin other than the alkali-soluble novolac resin may be incorporated, if necessary. Such an alkali-soluble resin includes for example, styrene-acrylic acid copolymer, methylmethacrylate-mathacrylic acid copolymer, alkali-soluble polyurethane resin, alkali-soluble vinyl resin as disclosed in J.P. KOKOKU (publication of examined application) No. Sho 52-28401, and alkali-soluble polybutyral resin. Further, a PS plate wherein a photosensitive layer of photopolymerizable photopolymer composition is provided on an aluminum plate as disclosed in U.S. Pat. Nos. 4,072,528 and 4,072,527, and a PS plate wherein a photosensitive layer comprising a mixture of an azide compound and a water-soluble polymer is provided on an aluminum plate as disclosed in GB Patent Nos. 1,235,281 and 1,495,861 are preferable.

Furthermore, the fountain solution composition of the present invention can be preferably applied to a CTP plate, which has been directly exposed by a visible or infrared laser, and examples thereof include a photopolymer type digital plate such as LP-NX manufactured by FUJI FILM Corporation, a thermal positive type digital plate such as LH-PI manufactured by FUJI FILM Corporation, a plate of on press processing type to be developed by a fountain solution and an ink, such as ET-S manufactured by FUJI FILM Corporation, and a thermal negative type digital plate such as LH-NI manufactured by FUJI FILM Corporation, and the like.

### EXAMPLES

The present invention will now be described more in detail by way of examples thereof. It should be noted that % used herein indicates % by weight unless otherwise mentioned.

### Examples 1-10 and Comparative Examples 1-9

A variety of concentrated fountain solution compositions of Examples 1-10 and Comparative Examples 1-9 were prepared according to the following preparation in the same manner, except for changing diol compounds and the compound represented by the general formula (I) or (II) as shown in Table 1 below, but using the equal weight thereof.

Formulation of the fountain solution composition (concentrated solution)

| Ingredients | Additive amount | |
|---|---|---|
| Ethylene glycol monoisobutyl ether | 200 | g |
| Ethylene glycol monotertiary butyl ether | 200 | g |
| Diol compounds shown in Table 1 | 120 | g |
| Compounds represented by general | 100 | g |
| formula (I) or (II) | | |
| Ammonium nitrate | 30 | g |
| Citric acid | 8 | g |
| Hydroxypropyl cellulose | 5 | g |
| N-octylpyrrolidone | 10 | g |

| | |
|---|---|
| Water | up to 1000 g in total |

Each concentrated fountain solution composition prepared above was diluted with water in a fountain solution tank so that a dilution rate became 2%, dissolution thereof was carried out by merely liquid circulation but not agitation, and then printing was performed, and the following evaluations were conducted.

The following assays were conducted for each fountain solution composition after printing 20000 sheets using Lithron26 printing machine from KOMORI Corporation with an ink: LEO-X Black L from TOYO INK MFG CO., LTD., ultra lightweight coat papers: OK topcoat+ from OJI Paper Co., Ltd., and a plate: PN-V from FUJI FILM Corporation.

### (1) Evaluation of Blanket Piling

After above printing, the blanket was removed and the height of deposit on a non-image area was measured with a stylus surface roughness meter (SURFCORDER) to evaluate blanket piling as a relative value to a value in a case using a fountain solution free from the diol compound and the compound represented by the general formula (I) or (II), the latter value being supposed to be 100 (see Comparative Example 1 in Table 1). The smaller the value is, the smaller the height of piling is, therefore preferable.

### (2) Evaluation of Deposition of Components

30 Liters of tap water was impounded in a fountain solution tank, cooled at a temperature of 10° C., and then 600 mL of each concentrated fountain solution was added thereto, merely liquid circulation was carried out, and an amount of deposition of components in the fountain solution, said deposition floating on the surface of the solution, was visually evaluated. The smaller the amount is, the evaluation result is more preferable.

¤: No deposition was generated at all.
∘: Immediately after addition of concentrated fountain solution, deposition was generated, and then dissolved within one minute.
Δ: Immediately after addition of concentrated fountain solution, deposition was generated, and then dissolved within 5 minutes.
x: Immediately after addition of concentrated fountain solution, deposition was generated, and then a small amount of remainder undissolved was still observed after 15 minutes.
xx: Immediately after addition of concentrated fountain solution, deposition was generated, and then a large amount of remainder undissolved was still observed after 15 minutes and more.

Results of the evaluations are shown in Table 1.

In Table 1, symbols used therein represent the following compounds.

(1): 2,4-diethyl-1,5-pentanediol
(2): 2-butyl-2-ethyl-1,3-propanediol
(3): 1,2-octanediol
Comparative compound (1): 2-ethyl-1,3-hexanediol
Comparative compound (2): 1,5-pentanediol
Comparative compound (3): 1,8-octanediol
Comparative compound (4): 1,9-nonanediol
Compound represented by formula (I) or (II)
(A): m-xylenesulfonic acid
(B): sodium m-xylenesulfonate
(C): sodium p-toluenesulfonate
(D): sodium p-xylenesulfonate
(E): sodium cumenesulfonate
(F): p-toluenecarboxylic acid
(G): salicylic acid
(H): 5-sulfosalicylic acid
Comparative compound (A): sodium 4-octylbenzene sulfonate

TABLE 1

| | | | Compound | | |
|---|---|---|---|---|---|
| | | | represented | | |
| | | | by general | | Deposition |
| | | Diol | formula | Blanket | of |
| Examples | | compound | (I) or (II) | piling | components |
| Example | 1 | (1) | (A) | 56 | ¤ |
| | 2 | (1) | (B) | 53 | ¤ |
| | 3 | (2) | (B) | 48 | ¤ |
| | 4 | (3) | (B) | 55 | ¤ |
| | 5 | (2) | (C) | 60 | ∘ |
| | 6 | (2) | (D) | 58 | ∘ |
| | 7 | (2) | (E) | 66 | Δ |
| | 8 | (2) | (F) | 68 | Δ |
| | 9 | (2) | (G) | 71 | Δ |
| | 10 | (2) | (H) | 71 | Δ |
| Comparative | 1 | No additive | No additive | 100 | ¤ |
| Example | 2 | (1) | No additive | 90 | x |
| | 3 | (2) | No additive | 94 | xx |
| | 4 | (3) | Comparative | 98 | xx |
| | | | compound | | |
| | | | (A) | | |
| | 5 | Comparative | No additive | 96 | ∘ |
| | | compound (1) | | | |
| | 6 | Comparative | (B) | 100 | ¤ |
| | | compound (1) | | | |
| | 7 | Comparative | (B) | 96 | ∘ |
| | | compound (2) | | | |
| | 8 | Comparative | (B) | 98 | Δ |
| | | compound (3) | | | |
| | 9 | Comparative | (B) | 100 | x |
| | | compound (4) | | | |

As seen from results in Table 1, the combination use of the specific diol compound and the compound represented by the general formula (I) or (II) remarkably inhibits blanket piling, and also inhibits the deposition of components in the fountain solution.

### Examples 11-17

Experiment was conducted in the same manner as Example 3 in Table 1, except that ethylene glycol monoisobutyl ether was replaced with an organic solvent shown in Table 2, and the following evaluation was carried out.

### (1) Evaluation of Blanket Piling

Same as Examples 1-10.

### (2) Evaluation of Deposition of Components

Same as Examples 1-10.

### (3) Evaluation of Minimum Value of Water Dial

Water dial equipped with the printing machine (dial value of from 1 to 99, this value is bigger, a rotating speed of the dampening roller becomes bigger, and an amount of water provided on a plate surface becomes larger) was changed gradually from a small value to a big value, and the value at which scumming on 40% dots area was resolved was measured and defined as “minimum value of water dial”. A difference of each minimum value of water dial in Examples 11 to 17 from the minimum value of water dial in Example 3 was measured, and said value was evaluated as a difference of minimum value of water dial. The smaller this value is, it follows that printing can be conducted with a smaller amount of water, therefore preferable.

Results of the evaluations are shown in Table 2.

In Table 2, symbols used in the organic solvent column represent the following compounds.

### Organic Solvent

S-(1): ethylene glycol monoisobutyl ether
S-(2): diethylene glycol monoisobutyl ether
S-(3): diethylene glycol mono n-butyl ether
S-(4): ethylene glycol mono t-butyl ether
S-(5): diethylene glycol mono n-propyl ether
S-(6): propylene glycol mono n-butyl ether
S-(7): dipropylene glycol mono t-butyl ether
S-(8): propylene glycol

TABLE 2

| | | | Deposition | difference of | |
|---|---|---|---|---|---|
| | Organic | Blanket | of | minimum value | |
| Example | solvent | piling | components | of water dial | Remarks |
| 3 | S-(1) | 48 | ¤ | 0 | favorable |
| 11 | S-(2) | 52 | ¤ | 2 | favorable |
| 12 | S-(3) | 53 | ¤ | 2 | favorable |
| 13 | S-(4) | 53 | ¤ | 5 | favorable |
| 14 | S-(5) | 54 | ¤ | 5 | favorable |
| 15 | S-(6) | 68 | Δ | 0 | |
| 16 | S-(7) | 70 | Δ | 5 | |
| 17 | S-(8) | 55 | ¤ | 12 | |

As seen from results in Table 2, when the organic solvent represented by the general formula (III) (S-(1) to S-(5)) is used, blanket piling and deposition of components are inhibited and simultaneously the minimum value of water dial is lower, and therefore these embodiments are particularly preferable.

### Examples 18-24

Experiment was conducted in the same manner as Example 3 in Table 1, except that N-octylpyrrolidone was replaced with a pyrrolidone derivative or an acetylene derivative shown in Table 3 below in an equal quantity, and the following evaluation was carried out.

### (1) Evaluation of Blanket Piling

Same as Examples 1-10.

### (2) Evaluation of Deposition of Components

Same as Examples 1-10.

### (3) Evaluation of Ink-Stain (Ink Feedback) on the Dampening Roller

After completion of the printing, ink-stain on the dampening roller were visually observed and ranked as follows.

∘: Little ink-stain
Δ: Slight ink-stain
x: Obvious ink-stain

Results are shown in Table 3.

TABLE 3

| | Pyrrolidone | | Deposition | Ink-stain on |
|---|---|---|---|---|
| | derivative/ | Blanket | of | dampening |
| Example | acetylene derivative | piling | components | roller |
| 3 | N-octylpyrrolidone | 48 | [symbol] | ◯ |
| 18 | no additive | 63 | [symbol] | Δ |
| 19 | P-(1) | 59 | [symbol] | Δ |
| 20 | P-(2) | 61 | [symbol] | Δ |
| 21 | A-(3) | 66 | [symbol] | Δ |
| 22 | A-(4) | 55 | [symbol] | ◯ |
| 23 | A-(5) | 62 | ◯ | Δ |
| 24 | A-(6) | 52 | [symbol] | ◯ |

The symbols in the pyrrolidone derivative/acetylene derivative column represent the following compounds.

### P-(1): N-methylpyrrolidone

### P-(2): N-buthylpyrrolidone

A-(3): 3,5-Dimethyl-1-hexyne-3-ol
A-(4): 3,6-Dimethyl-4-octyne-3,6-diol
A-(5): 2,4,7,9-Tetramethyl-5-decyne-4,7-diol
A-(6): adduct compound of 4 ethylene oxides to 2,4,7,9-tetramethyl-5-decyne-4,7-diol

As seen from results in Table 3, N-octylpyrrolidone, 3,6-Dimethyl-4-octyne-3,6-diol or an adduct compound of 4 ethylene oxides to 2,4,7,9-tetramethyl-5-decyne-4,7-diol is added to improve ink-stain on dampening roller and to show the effect of present invention preferably.

What is claimed is:

1. A fountain solution composition for lithographic printing characterized by comprising at least one selected from 2,4-diethyl-1,5-pentanediol, 2-butyl-2-ethyl-1,3-propanediol and 1,2-octanediol, and at least one selected from compounds represented by the following general formula (I) or (II): 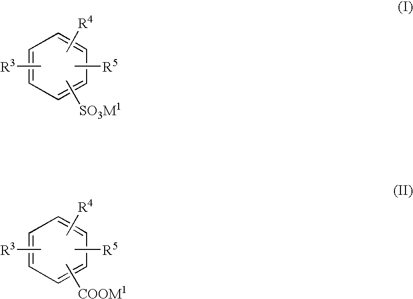
wherein R³ to R⁵ each independently represent hydrogen atom, an alkyl group having 1 to 4 carbon atoms, a hydroxyalkyl group having 1 to 4 carbon atoms, a hydroxyl group, a halogen atom, a mercapto group, —SO₃M¹ or —COOM¹, and M¹ represents hydrogen atom, an alkali metal or NH₄.

2. The fountain solution composition for lithographic printing according to claim 1, wherein the compound represented by the general formula (I) is m-xylenesulfonic acid, sodium m-xylenesulfonate or potassium m-xylenesulfonate.

3. The fountain solution composition for lithographic printing according to claim 1, further comprising at least one compound represented by the following general formula (III):
R₁—O—(CH₂CH₂O)ₘ—H (III)
wherein R₁ represents an alkyl group having 1 to 4 carbon atoms, and m represents an integer of 1 to 3.

4. The fountain solution composition for lithographic printing according to claim 1, further comprising a pyrrolidone derivative represented by the following general formula (VI): 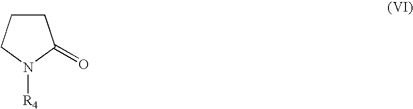
wherein R₄ represents an alkyl group having 2 to 12 carbon atoms.

5. The fountain solution composition for lithographic printing according to claim 1, further comprising at least one selected from the group consisting of acetylene glycols, acetylene alcohols, and an adduct compound of ethylene oxide and/or propylene oxide thereto.

6. A concentrated fountain solution composition for lithographic printing characterized by comprising at least one diol compound selected from 2,4-diethyl-1,5-pentanediol, 2-butyl-2-ethyl-1,3-propanediol and 1,2-octanediol in an amount of 5 to 25% by weight, and at least one selected from compounds represented by the following general formula (I) or (II) in an amount of 0.3 to 2 times with respect to the amount of the diol compound. 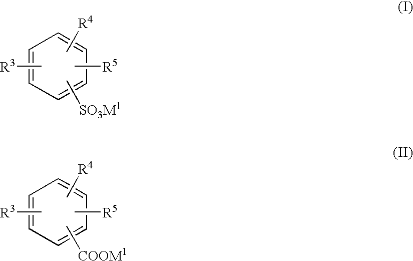
wherein R³ to R⁵ each independently represent hydrogen atom, an alkyl group having 1 to 4 carbon atoms, a hydroxyalkyl group having 1 to 4 carbon atoms, a hydroxyl group, a halogen atom, a mercapto group, —SO₃M¹ or —COOM¹, and M¹ represents hydrogen atom, an alkali metal or NH₄.

7. A rotary heat-set offset printing process wherein a fountain solution composition obtained by diluting the concentrated fountain solution composition according to claim 6, from 30 to 100 fold with water is used to print.
